(19) United States
(12) Patent Application Publication
(10) Pub. No.: US 2013/0115551 A1
(43) Pub. Date: May 9, 2013

(54) ELECTROPHOTOGRAPHIC TONER, A PRINTING SYSTEM FOR APPLYING SAID TONER ON AN IMAGE RECEIVING MEDIUM AND A METHOD FOR PREPARING SAID TONER

(71) Applicant: OCE TECHNOLOGIES B.V., Venlo (NL)

(72) Inventors: Roelof Hendrik EVERHARDUS, Lomm (NL); Michael T.J. VERHEGGEN, Weert (NL); Stefan VERLEG, Breda (NL); Lambertus M.L. VAN SAS, Helmond (NL)

(73) Assignee: OCE TECHNOLOGIES B.V., Venlo (NL)

(21) Appl. No.: 13/660,356

(22) Filed: Oct. 25, 2012

(30) Foreign Application Priority Data
Nov. 8, 2011 (EP) 11188183.5

(51) Int. Cl. G03G 9/00; G03G 15/08

(52) U.S. Cl. 430/105; 399/252; 430/111.4; 430/108.8; 430/137.21

(57) ABSTRACT

The invention relates to a toner for developing a toner image, the toner comprising a binder resin, a colorant, a first wax and a compatibilizer. The wax is finely dispersed within the toner. The compatibilizer has a melting transition, wherein the lower temperature limit of the melting transition is between 110° C. and 140° C. at the time of temperature rise in the DSC curve measured using a differential scanning calorimeter. The invention further relates to a printing system for applying the toner according to the present invention on an image receiving medium. The invention further relates to a method for preparing the toner according to the present invention.

### CROSS-REFERENCE TO RELATED APPLICATIONS

This application claims priority to Application No. 11188183.5-1217, filed in EP on Nov. 8, 2011, the entirety of which is expressly incorporated herein by reference.

### FIELD OF INVENTION

The invention relates to an electrophotographic toner comprising a wax and a compatibilizer. The invention also relates to a method for producing the toner comprising the wax and the compatibilizer. The invention also relates to a printing system using the toner comprising the wax and the compatibilizer.

### BACKGROUND OF THE INVENTION

In toner based printing systems wherein the toner is transferred to an image receiving medium and fixed by pressure and/or temperature, the robustness of the toner images on the image receiving means is restricted by the scratch and smear resistance of the binders of the toner. Especially for finishing processes of printed toner images, e.g. collecting and binding of several image receiving means, the robustness of the image is of importance.

In general waxes are known to be able to improve the robustness of the printed images. For toner images the Coefficient of Friction of the toner image may be decreased by proper distribution of the wax in the toner. As a result the robustness of the toner image is improved. In particular, the amount of smearing may be reduced. The improvement of the robustness of the toner image is in particular provided during the fusing process of the toner onto the image receiving medium. In particular, print robustness may be even further improved by introducing a second fusing step, wherein the wax in the toner is at least partly melted and transported to the surface of the toner image. The wax may preferably have a low viscosity, at least under fixing conditions, in order to be able to efficiently migrate to the surface of the toner image.

However, it may be difficult to homogeneously disperse the wax in the toner composition, depending on the nature of the wax and the other components of the toner, such as the binder resin and the colorant. Therefore, it may be advantageous to provide a compatibilizer to the toner composition. A compatibilizer is a component that improves the dispersion of the wax in the toner composition, resulting in the wax being finely dispersed throughout the toner composition. Compatibilizers for improving the dispersion of apolar poly-olefin waxes in toner compositions are known in the art. Commonly waxes and/or compatibilizers are selected for application in toner imaging systems, which have a low melting temperature range, typically in a temperature range starting below 110° C., in order that the components are at least partly molten during the fixing process of the toner on the image receiving medium at elevated temperature and the energy consumption of the fixing process is minimized. On the other hand the waxes are selected such that the melting temperature is above 50° C. in order that the wax does not impart the developing performance of the toner in the image developing process at a temperature between room temperature and 50° C.

In toner based printing systems, wherein the transfer of the toner between the developing means and the image receiving medium is provided by an intermediate image bearing means, durability of the developing performance of the printing system has been shown to be more critical to the use of toners comprising a wax component. Commonly applied waxes for reducing the Coefficient of Friction and enhancing the robustness of the toner image as well as commonly applied compatibilizers have shown to contaminate the developing means in long-term of a printing system comprising an intermediate image bearing means, such that parts of the printing system have to be cleaned and/or exchanged at a high rate.

It is therefore an object of the invention to provide an electrophotographic toner which shows good print robustness after printing and wherein the wax component is finely dispersed within the toner particles.

It is a further object of the invention to provide a printing system for applying the electrophotographic toner on an image receiving medium.

It is a further object of the invention to provide a method for preparing the electrophotographic toner.

### SUMMARY OF THE INVENTION

These objects are at least partially achieved in a toner for developing a toner image, the toner comprising a binder resin, a colorant, a first wax and a compatibilizer, the compatibilizer being a second wax, different from the first wax, said compatibilizer having a melting transition, wherein the lower temperature limit of the melting transition is between 110° C. and 140° C. at a time of temperature rise in a DSC thermogram measured using a differential scanning calorimeter.

The toner according to the present invention may be suitable to undergo a second fixing step. The toner according to the present invention may comprise a wax that is well dispersed in the toner composition. The toner according to the present invention may comprise a compatibilizer in a small amount, with respect to the amount of wax present in the toner. Furthermore, the toner according to the present invention may be a electrophotographic toner that does not pollute the printing system. The toner according to the present invention may show improved smearing resistance. Smearing is the phenomenon that toner applied to a receiving medium is smeared upon the application of a shear force to the toner image on the receiving medium.

### Wax

The toner according to the present invention comprises at least a first wax, the first wax being selected to provide improved print robustness to a printed image after fusing the printed image. Preferably, the first wax is a release wax. A release wax is a wax that is (partially) released from the toner particles at higher temperatures. When the release wax is released from the toner particles, the wax may migrate to the surface of the toner particle, thereby increasing the concentration of the release wax on the surface of the toner particles, thereby reducing the coefficient of friction and thereby improving the print robustness, such that the amount of smearing of the printed image may decrease.

The first wax may be selected from a polyalkylene wax, such as, but not limited to, a polyethylene wax, a polypropylene wax, or an ethylene-propylene copolymer wax.

The first wax preferably has a relatively low viscosity, at least at higher temperatures. At higher temperatures, for example temperatures in the range of 115° C.-170° C., such as from 120° C.-150° C., the viscosity may be relatively low. For example, the viscosity at 140° C. may be in the range of 5 mPa s to 500 mPa s, such as from 7 mPa s to 300 mPa s, for example from 10 mPa s to 200 mPa s. The low viscosity may enable the release wax to migrate from a position within the toner particle to a position on the surface of the toner particle. However, the ability of the first wax to migrate may not only depend on the viscosity at a certain temperature, it may also depend on other parameters, such as the affinity of the first wax with the other components in the toner, for example the binder resin and/or the colorant. The first wax may be an apolar wax. This apolar wax may show a low affinity with the binder resin and the colorant present in the toner. Therefore, it may be difficult to disperse the first wax well within the toner particles. If the first wax is not well dispersed within the toner particles, this may result in the presence of toner particles hardly containing any wax and/or the presence of toner particles mainly consisting of wax. This may negatively influence the robustness of the printing system and/or the robustness of the prints.

In the toner according to the present invention, a compatibilizer may be added to the toner composition to improve the dispersion of the first wax within the toner composition. However, the low affinity of the first wax with respect to the binder resin and/or the colorant may be beneficial during fusing. During a fusing step, it is desired that the first wax migrates to the surface of the toner particle. The first wax may migrate more easily if the affinity of the first wax with another component of the toner composition is low.

The first wax has a melting transition, wherein the maximum of the melting transition is in the range of from 60° C. to 170° C., such as from 90° C. to 150° C., preferably from 100° C. to 145° C., more preferably from 110° C. to 135° C.

The weight averaged molecular weight (M_{w}) of the first wax may be in the range of 750 g/mole to 10000 g/mole, for example from 1000 g/mole to 8000 g/mole, such as from 1500 g/mole to 6000 g/mole.

The number averaged molecular weight (Mₙ) of the first wax may be in the range of 700 g/mole to 5000 g/mole, for example from 850 g/mole to 4500 g/mole, such as from 900 g/mole to 4000 g/mole.

The first wax may be present in the toner in an amount of from 1 wt % to 10 wt %, based on the total weight of the toner.

In case the amount of first wax is less than 1 wt %, enough effect of the first wax may not be obtained. On the other hand, if the amount of first wax is more than 10 wt %, it may be difficult to obtain a fine dispersion of the wax in the toner composition, even if a compatibilizer is applied. Preferably, the amount of the first wax is from 3 wt % to 8 wt % based on the total weight of the toner. More preferably, the amount of the first wax is from 4 wt % to 7 wt % based on the total weight of the toner.

In chemistry, acid value (or “neutralization number” or “acid number” or “acidity”) is expressed as the mass of potassium hydroxide (KOH) in milligrams that is required to neutralize one gram of chemical substance. The acid number is a measure of the amount of carboxylic acid groups in a chemical compound, or in a mixture of compounds. In a typical procedure, a known amount of sample dissolved in a solvent is titrated with a solution of potassium hydroxide with known concentration and with a color indicator, e.g. phenolphthalein or by using a combined electrode (potentiometric titration).

The first wax preferably has an acid value from 0 mg KOH/g to 50 mg KOH/g. For example the wax has an acid value from 0.1 mg KOH/g to 30 mg KOH/g, such as from 0.2 mg KOH/g to 20 mg KOH/g, for example from 0.4 mg KOH/g to 15 mg KOH/g. More preferably the wax has an acid value from 0.3 mg KOH/g to 10.

The wax is finely dispersed in the binder resin. In particular the domains of wax in the dispersion of the wax in the binder resin of the toner may have a diameter of less than about 10 μm, preferably 0.1 μm-5 μm, more preferably 0.5 μm-2 μm, even more preferably 0.7 μm-1.5 μm.

In a preferred embodiment, the lower temperature limit of the first wax melting transition is between 100° C. and 140° C. at the time of temperature rise in the DSC thermogram measured using a differential scanning calorimeter. The first wax melting transition at the time of temperature rise in the DSC thermogram was measured at a heating rate of 10° C./min at the time of rise according to the ASTM D3418 Standard using a differential scanning calorimeter.

### Binder Resin

The toner comprises at least one binder resin, for example a thermoplastic polymer or a pressure-sensitive polymer. Common binder resins are styrene polymers, styrene copolymers such as styrene acrylates, styrene-butadiene copolymers and styrene maleic acid copolymers, cellulose resins, polyamides, polyethylenes, polypropylenes, polyesters, polyurethanes, polyvinyl chlorides, epoxy resins and so on. The resin binders in the toner may be a single component or a mixture of various binder resins. Preferably, the binder resin has a weight-averaged molecular weight of between 200 and 100,000, for example a weight-averaged molecular weight of between 500 and 50,000, more preferably a weight-averaged molecular weight of between 1000 and 30,000. This molecular weight may, for example, be adapted to the required mechanical properties of the image or to the intrinsic properties of the image-forming process. The glass transition temperature of the binder resin is in the range 45° C. to 85° C., preferably in the range 50° C. to 80° C., for example, in the range 55° C. to 75° C. In an even more preferred embodiment, the glass transition temperature of the binder resin is in the range 60° C. to 70° C.

In another embodiment the binder resin comprises a mixture of a polyester resin and an epoxy polymer. In particular in the toner according to the invention, the ratio between the polyester resin and the reaction product of the epoxy resin and phenol compound ratio may be varied between 80:20 and 20:80, such as may be varied between 70:30 and 30:70, more preferably may be varied between 60:40 and 40:60. The temperature difference between the glass transition temperature and the lower fusing limit of the toner powders according to the embodiment is also significantly reduced in comparison with the temperature difference between the glass transition temperature and the lower fusing limit of toner powder prepared with polyester resin without the addition of the epoxy reaction product. Consequently, while powder stability is retained the fixing temperature of such toner powders is lower so that the energy consumption for fixing is reduced.

Suitable epoxy resins, for example, are the Epikote resins (Nuplex Resins BV), such as Epikote 828, Epikote 838 and Epikote 1001. In addition, many other epoxy resins may be used which contain one or more epoxy groups per molecule. These epoxy resins may be saturated or unsaturated, aliphatic, cycloaliphatic, aromatic or heterocyclic, and may be substituted with substituents such as halogen atoms, hydroxyl groups, alkyl, aryl or alkyl-aryl groups, alkoxy groups and the like. The phenol compounds suitable in the toner powder according to the invention are those compounds which have at least one hydroxyl group bonded to an aromatic nucleus. Mainly etherification takes place on reaction between the epoxy resin and the phenol compound, thereby forming the epoxy resin. However, not all epoxy groups present may react with a phenol compound, resulting in the presence of unreacted epoxy groups within the resin. It may be desirable to control the amount of free epoxy groups present within the resin, for example because of the HSE effects of epoxy functional groups, or because of the reactivity of the resin towards other components present in the toner. The amount of free epoxy groups may be suitably controlled by adding a blocking agent. A blocking agent is a compound, which reacts with the epoxy group, such that the epoxy group is converted into another functional group, for example an ether functional group. Thereby, the epoxy group is prevented from reacting further. For example, a phenol compound having one hydroxyl group bonded to an aromatic nucleus may be used for as blocking agent in a blocking reaction of the epoxy resin.

Examples of suitable phenols as blocking agent are phenol, p-cumylphenol, o-tert.butylphenol, p-sec. butylphenol, p-phenylphenol, octylphenol, p-cyclohexylphenol and -naphthol. Other blocking agents, for example, monofunctional carboxylic acids, are also suitable. Examples of suitable carboxylic acids are phenylacetic acid, diphenylacetic acid and p-tert.butylbenzoic acid.

The selection of a specific polyester resin depends on the required use of the toner powder. A polyester may be formed from a reaction between a diol and a carboxylic acid. Suitable diols are, inter alia, etherified bisphenols, such as polyoxyethylene(2)-2,2-bis(4-hydroxyphenyl)-propane, polyoxypropylene(3)-2,2-bis(4-hydroxyphenyl)-propane, polyoxypropylene(3)-bis(4-hydroxyphenyl)-sulphone, polyoxyethylene(2)-bis(4-hydroxyphenyl)-sulphone, polyoxypropylene(2)-bis(4-hydroxyphenyl)-thioether and polyoxypropylene(2)-2,2-bis(4-hydroxyphenyl)-propane or mixtures of these diols, in which a plurality of oxyalkylene groups per molecule of bisphenol may be present. This number is preferably between 2 and 3 on average. It is also possible to use mixtures of etherified bisphenols and (etherified) aliphatic diols, triols, etc. Examples of suitable carboxylic acids are phthalic acid, terephthalic acid, isophthalic acid, cyclohexane dicarboxylic acid, fumaric acid, maleic acid, malonic acid, succinic acid, glutaric acid, adipic acid and anhydrides of these acids. Furthermore esters, e.g. methyl esters of these carboxylic acids, are suitable.

In a further embodiment the polyester resin has a number-averaged molecular weight of at least 2500, for example 2500-250 000, preferably 3000-100 000, more preferably 5000-50 000. The epoxy resin has a number-averaged molecular weight of less than 1200, for example 100-1200, preferably 200-500 and the epoxy groups of the epoxy resin are blocked for at least 60% by a monofunctional phenol compound, for example 60%-100%, preferably 65%-95%, more preferably 70%-90%.

Particularly preferred is a toner powder whose polyester resin is mainly a reaction product of ethoxylated 2,2-bis(4-hydroxyphenyl)propane, a phtalic acid and adipic acid. More preferably the phtalic acid is terephtalic acid or isophtalic acid. A toner powder of this kind has a sufficiently high glass transition temperature and also a surprisingly low lower fusing limit, so that the energy required to fix a toner image prepared with this toner powder is relatively low.

### Colorant

The colorant may be a pigment or a dye. In a preferred embodiment, the colorant may be a pigment, such as carbon black or a magnetic pigment. As a magnetic pigment, a metal, a metal oxide, or a mixture may be used. For example, iron, cobalt, nickel or iron oxide may be used as a magnetic pigment. By proper mixing of the magnetic pigment in the toner a color of the toner, a magnetic property of the toner and/or the electrical property of the toner may be easily adjusted using conventional mechanical processes. In an embodiment, the colorant may be present in an amount of from 1 wt %-70 wt %, for example from 2-60 wt %, for example from 5 wt %-20 wt % or from 25 wt % to 55 wt %, based on the total weight of the components.

The magnetic pigment is preferably uniformly dispersed in the binder resin of the toner, the dispersion of the inorganic component in the binder resin of the toner having a number average diameter of less than 10 μm, preferably from 0.05 μm to 10 μm, more preferably from 0.1 μm to 5 μm, even more preferably from 0.2 μm to 2 μm.

In particular the toner comprising the magnetic component may have a magnetization in the range of 10 mVs/ml to 50 mVs/ml, such as in the range 10 mVs/ml to 40 mVs/ml, preferably in the range 12 mVs/ml to 20 mVs/ml or alternatively in the range 25 mVs/ml to 35 mVs/ml. It is known that a toner having the desired magnetization may be obtained by dispersing a proper amount of a magnetic component in the binder resin.

### Compatibilizer

The compatibilizer may serve to improve the dispersion of the first wax within the toner composition. This may be done, for example, by improving the interaction between the different components of the toner composition. The compatibilizer in accordance with the present invention may be a second wax, different from the first wax. The second wax may be selected from the group consisting of a modified polyalkylene wax, such as an oxidized polyalkylene wax, or an oxidized polyalkylene wax converted into an amide. In addition, the second wax may be an oxidized polyalkylene wax converted into a salt. For example, the second wax may be a alkali salt, such as a Na—, K— or a Li— salt of an oxidized polyalkylene wax, an earth alkali salt, such as a Be—, Mg—, Ca—, Sr—, Ba— salt of an oxidized polyalkylene wax, or an ammonium, alkylammonium, arylammonium or alkylarylammonium salt of an oxidized polyalkylene wax. Non-limiting examples of oxidized polyalkylene waxes are an oxidized polyethylene wax or an oxidized polypropylene wax, for example an oxidized HDPE (High Density PolyEthylene) wax. Commercially available examples of such waxes include the high density oxidized polyethylene waxes AC 307a, AC 316, AC325, AC 330, AC 392, AC 395a, Acumist A6 and Acumist A12 (Honeywell) as well as the high density oxidized polyethylene wax Ceraflour 950 (Byk).

Without wanting to be bound to any theory, it is believed that the compatibilizer brings a plurality of components, showing low affinity towards one another in close proximity, thereby obtaining a better dispersion of the components in the mixture. This may be achieved, e.g. by applying a compatibilizer comprising two distinct functional part, each of which shows a preferred interaction with at least one of the other components of the wax. The compatibilizer comprises both the first and the second functional part and consequently, these distinct functional parts, each having a distinct chemical nature, may be in relatively close proximity of one another, since they are situated in the same molecule, being the second wax or a derivative thereof. In case the first functional part shows a preferred interaction with the first wax and the second functional part shows a preferred interaction with the colorant and/or binder, then the first functional part may preferably be in close proximity of the first wax and the second functional part may be in close proximity of the colorant and/or binder. Because the first and the second functional part are in relatively close proximity as well, since they are part of the same molecule, the first wax that in itself does not show much interaction with the binder resin and/or the colorant may be brought into closer proximity of the binder resin and/or the colorant by the compatibilizer. As a consequence, the first wax may be better mixed with the other components and thus, the first wax may be better dispersed in the toner composition if a compatibilizer is added to the toner composition.

The second waxes comprise two different functional parts. A first functional part may be the middle part of the chain, not comprising the end groups of the chain. This first functional part may consist basically of —(CH₂CH₂)— units. In addition, other units, such as —(C((CH₂)ₙCH₃)HCH₂)— units may be present, wherein n is an integer from 1-20. These latter units may be present, for example if the second wax is a polypropylene wax or a ethylene-propylene wax. Therefore, this first functional part of the second waxes may have a chemical nature, similar to the chemical nature of the first wax, which may preferably be a polyalkylene wax. The first functional part may be apolar. In case compounds have a similar chemical nature, they tend to mix well.

A second functional part may be the end group of the second wax. Polymers may have a different functional group at the end of the chain than in the middle of the chain. Consequently, the chemical nature of the ends of the chain may be different than the chemical nature in the middle of the chain. For example, oxidized waxes may have a carboxylic acid group at an end of the polymer chain. Alternatively, waxes may have a different functional group at the end of the polymer chain, such as, but not limited to an ester functional group, a hydroxyl functional group, an amine functional group or an amide functional group.

The second functional part of the second wax may have a polar character. Thus, the chemical nature of the first and second functional part may differ. In a toner according to the present invention, the binder resin may be a polar binder resin or a binder resin comprising polar parts. In addition, the colorant may be a polar component. For example, the colorant may be a magnetic colorant, such as a metal oxide. A metal oxide may have a polar nature. Thus, the second functional part of the second wax may have a similar chemical nature as (a part of) the binder resin and/or the colorant.

In case the first functional part shows a preferred interaction with the first wax and the second functional part shows a preferred interaction with the colorant and/or binder then addition of a compatibilizer to the toner composition may result in the first wax being better dispersed in the toner composition.

The second wax may be present in the toner in an amount of from 0.5 wt % to 10 wt %, based on the total weight of the toner.

In case the amount of second wax is less than 0.5 wt %, not enough effect of the compatibilizer may be obtained. On the other hand, if the amount of compatibilizer is more than 10 wt %, the physical properties of the toner may be changed and the print quality obtained using the toner may decrease. Preferably, the amount of compatibilizer is from 2 wt % to 6 wt % based on the total weight of the toner. More preferably, the amount of compatibilizer is from 3 wt % to 5 wt % based on the total weight of the toner.

In an embodiment, the weight averaged molecular weight (M_{w}) of the second wax is in the range of 500-30,000 g/mole. Preferably, the M_{w} is in the range of 1000-25,000 g/mole. More preferably, the M_{w} is in the range of 2500-20,000 g/mole, such as from 3000-15,000 g/mole or from 5000-18,000 g/mole.

The number averaged molecular weight (Mₙ) of the second wax is preferably in the range of 500-15,000 g/mole. Preferably, the Mₙ is in the range of 750-10,000 g/mole. More preferably, the Mₙ is in the range of 1000-7000 g/mole or 2000-8000 g/mole.

In a further embodiment, the oxidized polyethylene wax may more preferably have a polydispersity between 1.4 and 3.5. The polydispersity D is the ratio between the weight average molecular weight (M_{w}) of the wax and the number average molecular weight (Mₙ) of the wax. In a further embodiment, the oxidized polyethylene wax may more preferably have a polydispersity between 1.5 and 3.3. In an even further embodiment, the oxidized polyethylene wax may more preferably have a polydispersity between 1.6 and 3.0.

In addition, to prepare a toner according to another embodiment of the present invention, it is preferred that the compatibilizer has an acid value from 4 mg KOH/g to 80 mg KOH/g. For example the compatibilizer has an acid value from 6 mg KOH/g to 60 mg KOH/g, such as 8 mg KOH/g to 55 mg KOH/g or 15 mg KOH/g to 50 mg KOH/g. More preferably the compatibilizer has an acid value from 12 mg KOH/g to 45 mg KOH/g, such as 20 mg KOH/g to 40 mg KOH/g, for example from 25 mg KOH/g to 35 mg KOH/g.

The compatibilizer has a melting transition, wherein the lower temperature limit of said compatibilizer melting transition is in a temperature range of 110° C. to 140° C. Preferably, the lower temperature limit of the compatibilizer melting transition is in a temperature range of 115° C. to 130° C. More preferably, the lower temperature limit of the compatibilizer melting transition is in a temperature range of 120° C. to 125° C. In a known printing system, the toner may be fixed onto an image receiving medium at a fixing temperature of 90° C.-110° C. The term fixing as used herein may also comprise transfusing. Using toner comprising said compatibilizer, no long-term contamination of the printing system or deterioration on the developing performance of the toner has been observed. If the melting transition of the compatibilizer starts lower than 110° C., the durability of the development performance decreases. Thus the lower limit temperature of said compatibilizer melting transition according to the present invention is at least 110° C. or higher.

Herein the lower limit temperature of a melting transition is defined as being the temperature at which at least less than 10% fraction of the solid compatibilizer is molten, when measured at a heating rate of 10° C./min at the time of rise according to the ASTM D3418 Standard using a differential scanning calorimeter. In a preferred embodiment the melted fraction of the wax at 110° C. is at least less than 5% of the compatibilizer, when measured under the same conditions.

In an embodiment, the compatibilizer has a melting transition, having a melting peak in a temperature range of 120° C. to 155° C. at the time of rise in the DSC thermogram measured using a differential scanning calorimeter.

In an embodiment, the compatibilizer provides a strong affinity towards the colorant. In this embodiment, the compatibilizer and the colorant have a strong interaction. As a result, the compatibilizer may be retained in a toner particle, even if the compatibilizer is in a molten state.

The ratio between the first wax and the compatibilizer, may be in the range of from 20:1 to 1:10, preferably in the range of from 10:1 to 1:5, such as from 8:1 to 1:3 or from 7:1 to 2:1, based on the weight of the amount of first wax and the weight of the amount of the compatibilizer present in the toner. Thus, the first wax may be dispersed in the toner according to the present invention with a relatively low amount of compatibilizer.

### Other Additives

The toner powder may also contain other additives, the nature of which depends on the way in which the toner powder is applied. Thus toner powder for the development of latent magnetic images, toner powder which is fed by magnetic conveying means to an electrostatic image to be developed, or toner powder for Magnetic Ink Character Recognition (MICR) applications, will also have to contain magnetisable or magnetic material, usually in a quantity of 30 to 70% by weight. Toner powders which are used for the development of electrostatic images may also be rendered electrically conductive in manner known per se, by finely distributing electrically conductive material, e.g. carbon, tin oxide, copper iodide or any other suitable conductive material, in appropriate quantity in the powder particles or depositing it on the surface of the powder particles. The electrical conductive surface layer of the toner may comprise a component selected from a) a carbon particulate, b) an electrical conductive inorganic component, such as a metal oxide particle, c) an electrical conductive polymer, such as a doped conjugated conductive polymer, or d) a combination of these components.

The toner according to the present invention is suitable for developing a toner image. The toner may be a single component toner or a two-component developer, comprising a toner particulate and a magnetic carrier.

The single component toner may be a magnetic attractable toner. The magnetic property may be provided to the toner by incorporating a magnetic component into the toner. The magnetic component may be a magnetite, a ferrite or the like. In an embodiment, the magnetic component may also function as a colorant.

If, for the development of electrostatic images, the toner powder is used in a so-called two-component developer, in which the toner powder is mixed with carrier particles, then the toner powder particles may also contain a charge control agent that causes the toner powder particles, upon tribo-electric charging, to assume a charge whose polarity is opposed to that of the electrostatic image to be developed. The known materials suitable for this purpose can be used as carrier particles, e.g. iron, ferrite or glass, while the particles may be provided with one or more layers completely or partially covering the carrier particles.

The known materials may be used for the magnetisable or magnetic material, electrically conductive material or charge control agent. Also possible are additions, for example, to increase the powder stability or improve the flow behavior. Silica is a conventional additive for this purpose, for example.

In an aspect of the invention, a printing system for applying a toner on an image receiving medium is provided, the toner comprising:
(i) a binder resin;
(ii) a colorant; and
(iii) a first wax; and
(iiii) a compatibilizer, the compatibilizer being a second wax different from the first wax, said compatibilizer having a melting transition, wherein the lower temperature limit of the melting transition is between 110° C. and 140° C. at a time of temperature rise in a DSC thermogram measured using a differential scanning calorimeter,
the printing system comprising:
(A) a developing means configured for in operation developing a toner image,
(B) an intermediate image bearing means configured for in operation transferring the toner from the developing means to the intermediate image bearing means in a first transfer zone and for transferring the toner from the intermediate image bearing means to an image receiving medium in a second transfer zone.

The toner of the present invention is capable of being satisfactorily transferred on a receiving material in a wide temperature range. In case the printing system, wherein the toner according to the present invention may be used, comprises a two-step procedure to transfer the toner onto an image receiving medium, the printing system may comprise an intermediate image bearing means. In such a printing system, the toner may be transferred to the intermediate image bearing means in a first transfer zone and may be transferred from the intermediate image bearing means to the image receiving member in a second transfer zone. In accordance with the present invention, in particular the toner image may be developed by the developing means and said developed toner image may be transferred to the intermediate image bearing means in the first transfer zone in a temperature range from 20° C. to 60° C. In particular the transfer of the toner image from the intermediate image bearing means to the image receiving medium in the second transfer zone may be carried out in a temperature range from 80° C. to 110° C. However, the toner according to the present invention is not limited to a toner suitable only for use in a printing system applying a two-step procedure to transfer the toner onto an image receiving medium. The toner may also be applied in other printing systems, such as a printing system, wherein the toner image is transferred to the image receiving medium without the use of an intermediate image bearing means.

In an embodiment the printing system comprises two image-forming units and two images may in operation be transferred simultaneously from two intermediate image bearing means to both opposite surfaces of the image receiving medium in the second transfer zone. The transfer nip in the second transfer zone is formed by arrangement of the two intermediate image bearing means near the second transfer zone. The two intermediate image bearing means are configured to in operation contact the image receiving medium in the second transfer zone. The fixing means is arranged away from the transfer zone and is configured in operation to fix the toner images applied onto at least one of the opposite sides of the image receiving medium. As a result both toner images may be simultaneously fixed on the image receiving medium.

In an embodiment, in the second transfer zone, the toner is transferred from the intermediate image bearing means to an image receiving medium in a transfuse step. In this embodiment, the fixing of the toner may be carried out at the same time and in cooperation with the transfer of the toner from the intermediate image bearing means to the image receiving medium. This embodiment enables a compact and simple construction for transferring and fusing (also known as fixing) the toner onto the image receiving medium.

During transfuse the toner image may be fixed such that it is scarcely removed, if at all, under mechanical loads such as folding and rubbing. The fusing temperature in these conditions should be as low as possible in connection with minimum energy consumption. The working range of a toner powder may preferably be so wide that any temperature inequalities occurring in the fusing station do not result in visually noticeable differences in the print and/or do not result in contamination of the system by the toner. The working range of a toner powder is defined as the temperature range between the lower fusing limit, the lowest possible fixing temperature at which the toner image is still adequately fixed, and the upper fusing limit, the maximum fixing temperature at which, using for example the hot-roll fixing method, no toner is deposited on the fixing roller (the “hot roll”).

During transfuse, it is preferred that the system is not contaminated with toner. For example, it is preferred that the intermediate image bearing means are not contaminated. When the intermediate image bearing means are contaminated with toner, toner may be present in unwanted places in later developed toner images. To prevent the system from being contaminated with toner, it is preferred that the components forming the toner composition do not contaminate the printing system. Therefore, it is preferred that the components of the toner do not melt during the transfuse process. The transfuse takes place in the second transfer zone. As stated above, the transfuse of the toner image from the intermediate image bearing means to the image receiving medium in the second transfer zone may be carried out in a temperature range from 80° C. to 110° C. The compatibilizer has a melting transition, the lower temperature limit of the melting transition being between 110° C. and 140° C. at a time of temperature rise in a DSC thermogram measured using a differential scanning calorimeter. Therefore, the compatibilizer does not melt during the transfuse step and as a consequence, the compatibilizer may not contaminate the printing system.

It is further preferred that the first wax does not migrate from the toner particles during the transfuse step and that the first wax does not contaminate the printing system.

In an embodiment, the printing system further comprises:

(C) fusing means for in operation fusing the toner image on the receiving medium, the fusing means being provided downstream of the intermediate image bearing means in a transfer direction of the image receiving medium in the printing system.

In this embodiment, the toner image is fused onto image receiving medium after the transfer of the toner image on the image receiving medium. This embodiment provides a bigger operational freedom to adjust the fixing means. For example the fusing temperature may be increased, while maintaining a lower temperature of transfer. As a consequence, process conditions, such as temperature and pressure, may be optimized for each individual process step. The toner image may be fixed onto the image receiving medium in a temperature range of from 110° C. to 190° C. Preferably, the toner image may be fused onto the image receiving medium in a temperature range of from 120° C. to 180° C. More preferably, the toner image may be fused onto the image receiving medium in a temperature range of from 130° C. to 160° C. Said fusing temperature may improve the print robustness even further by further flattening the toner images and/or accumulation of the wax on the surface of the toner image.

The fusing means may be provided in combination with the transfuse step as described above or may not be combined with another fusing or transfusing step. By introducing a second fuse step into the printing process, the print robustness of the toner image on the image receiving medium may be further improved compared to a process comprising one fuse step. In addition, a fluid release agent, such as an oil, may optionally be provided during fixing in the fusing means, in order to improve the fixing temperature latitude and/or fixing speed. However, when using the toner according to the present invention, the first wax comprised in the toner may be a release wax. A release wax is a wax that is (partially) released from the toner particles at higher temperatures. When the release wax is released from the toner particles, the wax may migrate to the surface of the toner particle, thereby increasing the concentration of the release wax on the surface of the toner particles. When a relatively high concentration of the first wax is present on the surface of a toner particle when the toner image is fused, a smooth surface of the toner image may be obtained after fusing of the toner image, thereby improving the print robustness of the toner image. Therefore, it may not be necessary to provide an oil during fusing in the fusing means.

In an aspect of the invention, a method for producing the toner in accordance with the present invention is provided, the method comprising the steps of:
(i) providing a binder resin;
(ii) providing a colorant;
(iii) providing a first wax, and;
(iv) providing a compatibilizer, the compatibilizer being a second wax different from the first wax, said compatibilizer having a compatibilizer melting transition, wherein the lower temperature limit of the melting transition is between 110° C. and 140° C. at a time of temperature rise in a DSC thermogram measured using a differential scanning calorimeter,
(v) mixing the binder resin, the colorant the first wax and the compatibilizer in a melt kneading process in a melt temperature range between 110° C. to 140° C., such that the first wax is finely dispersed in the binder.

In another embodiment of the method in accordance with to the present invention, the melt kneading process comprises a first melt kneading step and a second melt kneading step, wherein in the first melt kneading step the binder resin, the colorant and the compatibilizer are mixed, and wherein in the second melt kneading step the mixture obtained in the first melt kneading step is mixed with the first wax.

This melt kneading process may be carried out in two separate extrusion processes, or alternatively, the first wax may be added to the melt kneading process via a second inlet to a melt kneader, at a position in between a first inlet of the melt kneader and an outlet of the melt kneader.

In another embodiment of the method according to the present invention, the first melt kneading step is carried out at a higher temperature than the second melt kneading step. For example, the first melt kneading step may be carried out at a temperature, such that the compatibilizer is in a molten state during the first melt kneading step. The second melt kneading step may be carried out such that the first wax and the compatibilizer are not in a molten state.

The toner of the present invention may be prepared by conventional mechanical processes. The conventional method of preparing a toner powder is to mix the constituents in the melt, cool the melt, and then grind and classify it to the correct particle size. The toner comprising the wax is adapted to grinding and satisfies requirements in respect of toughness and brittleness.

The toner particles in accordance with the present invention have a number averaged particle size of (D50) in the range of 4 μm-25 μm, preferably in the range of 8 μm-20 μm, for example 12 μm-18 μm. In a collection of particles, having a particle diameter distribution, the number averaged particle size D50 is defined as the diameter that splits the distribution, such that 50% of the particles has a diameter larger than D50 and 50% of the particles has a diameter smaller than D50.

### BRIEF DESCRIPTION OF THE DRAWINGS

Hereinafter, the present invention is further elucidated with reference to the appended drawings showing non-limiting embodiments and wherein

FIG. 1 shows a schematic view of a print engine in which a method according to the invention may be used.

FIG. 2 shows a DSC curve during the first scan of heating of the compatibilizer used in the toner of examples 1, 2 and 4.

FIG. 3 shows a DSC curve during the first scan of heating of the first wax used in the toner of examples 1 and 6.

FIG. 4 shows the Loss Compliance of toners of Examples 1, 2 and 4, measured at 100 rad/s

### DETAILED DESCRIPTION OF THE DRAWINGS

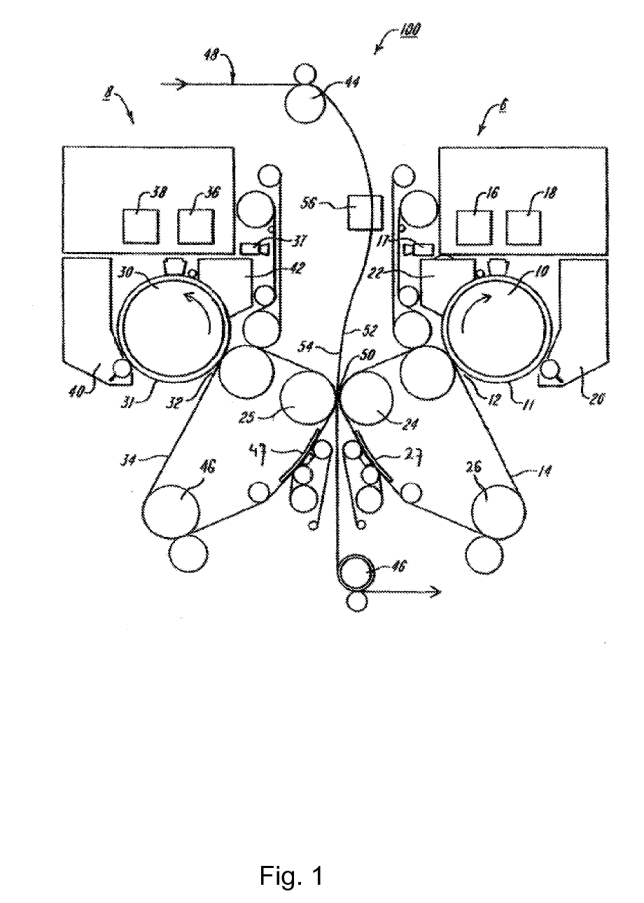

FIG. 1 shows a schematic view of a printer 100 comprising two image-forming units 6 and 8. This printer is known from American U.S. Pat. No. 6,487,388. As shown in FIG. 1, the printer is equipped to print an endless receiving medium 48. To this end, the printer is equipped with clamping elements 44 and 46. In another embodiment (not shown), the printer has been modified to print loose sheets of a receiving medium. The image-forming units, or developing means, 6 and 8 may be used to form images on the front 52 and back 54 respectively of the receiving medium 48, said images being transferred onto this medium at the level of the single transfer nip 50.

Image-forming unit 6 comprises a writing head 18 consisting of a row of individual printing elements (not shown), in this embodiment a row of so-called electron guns. By application of this writing head, a latent electrostatic charge image may be produced on the surface 11 of image medium 10. A visible powder image is developed on this charge image, using a toner inside this development terminal 20. This toner may be e.g. a toner according to the present invention. The toner according to the present invention consists of individual toner particles which have a core that is based on a plastically deformable resin. In this embodiment, the toner particles also comprise a magnetic pigment that is dispersed within the resin. The particles are coated on the outside in order to control their charging. At the level of a primary transfer nip 12, the visible powder image is transferred onto intermediate medium 14. This medium is a belt that consists of silicon rubber supported by a tissue. Toner residues on the surface 11 are removed by application of cleaning terminal 22, following which the charge image is erased by erasing element 16. Corresponding elements of image-forming unit 8 are indicated using the same reference numbers as the elements of unit 6 but increased by 20 units (as described in detail in the patent mentioned).

The images that are formed on the intermediate media 14 and 34 are transferred onto the receiving medium 48 at the level of the transfer nip 50. To this end, both intermediate media are printed on the receiving medium by application of the print rollers 24 and 25, where the images are transferred onto and fused with medium 48 as a result of this pressure, heat and shearing stresses. To this end, the receiving medium is preheated in terminal 56 and the intermediate media themselves will be heated by heating sources located in rollers 24 and 25 (not shown). Beyond transfer nip 50, the intermediate media are cooled down in cooling terminals 27 and 47. This is to avoid the intermediate media becoming too hot at the level of the primary transfer nips 12 and 32 respectively. When the printer is on standby, the temperature of the intermediate media is lower than for a proper transfuse step in nip 50. As soon as it is known when the next receiving medium needs to be printed, a signal will pass to the heating elements located in the rollers 24 and 25 to heat the corresponding intermediate medium.

As is known from U.S. Pat. No. 5,970,295, both images in the feed-through direction of the receiving medium 48 are brought into register with one another by checking the writing moments of both writing heads 18 and 38, as well as the rotating speeds of image media 10 and 30, and the intermediate media 14 and 34.

In the embodiment shown, the intermediate media are driven via rollers 26 and 46. The rotating speeds of the intermediate media 14 and 34 will thus be controlled and kept equal. Image media 10 and 30 do not have their own drive facility and are driven by the mechanical contact between the intermediate media in the transfer nips 12 and 32 respectively. As both sets of intermediate media and image media are never exactly the same length, the time that elapses between writing a latent image using writing head 18 and transferring the corresponding toner image in the secondary transfer nip 50 for the drive shown will always be different to the time that elapses between writing a latent image using writing head 38 and transferring the corresponding toner image in the secondary transfer nip 50. This time difference can be compensated by adapting the writing moment of either writing head.

Optionally, a fusing station (not shown) may be provided after roller 46, to fuse the toner image on the receiving medium 48. Depending e.g. on the nature of the transfer step in nip 50, the fusing station may be a first or a second fusing station.

Optionally, finishing devices (not shown) may be provided in combination with the printer 100. For example, the media that have been outputted by the printer may undergo finishing operations, such as punching and/or folding, bookbinding or being put in an envelop. The media that have been outputted by the printer may be transferred to the finishing devices directly, or a plurality of the outputted media may be collected, for example on a stacker, the plurality of media later being transferred to a finishing device.

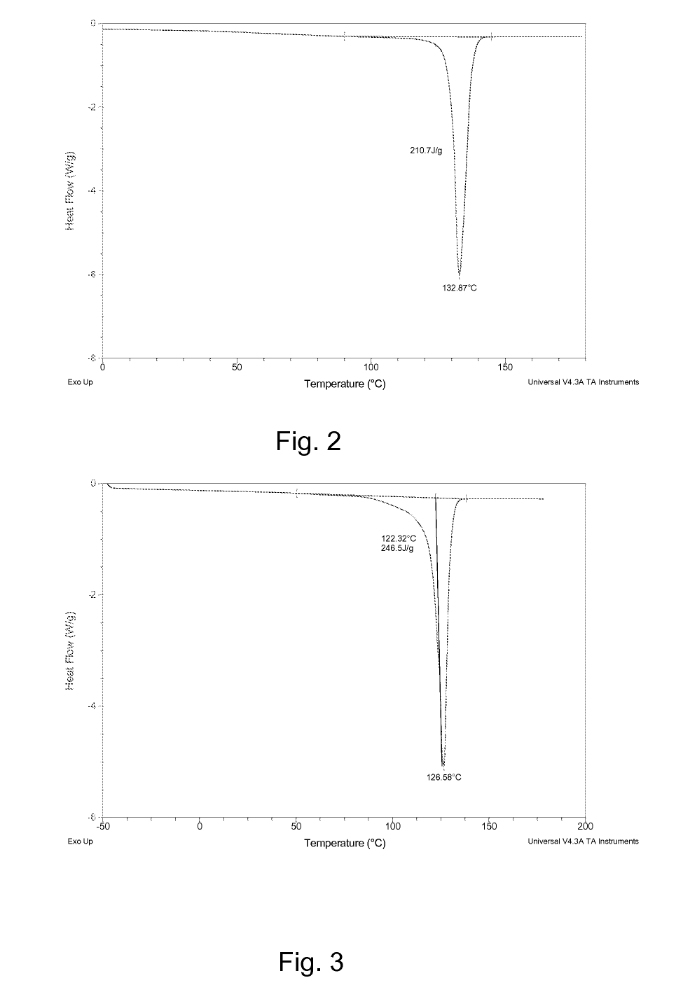

The melting transition of the compatibilizer AC-330 (i.e. a second wax in accordance with the present invention), as used in the toners according to examples 1, 2 and 4 was measured using differential scanning calorimeter. The thermogram is shown in FIG. 2. The compatibilizer has a melting transition which starts above 110° C., a melting peak in the range 130 to 134° C. AC-330, as well as other compatibilizers in accordance with the present invention does not have a melting transition between room temperature and 110° C. In FIG. 2, the first heating scan is given for the compatibilizer AC 330, showing the narrow melting range between 110° C. and 140° C. In case such a high melting compatibilizer is dispersed in the toner, the temperature range of compatibilizer melting transition has substantially not changed, and the lower limit temperature of the compatibilizer melting transition in the toner is also at least 110° C. or higher.

The melting transition of the first wax Polywax 2000, as used in the toners according to examples 1 and 6 was measured using differential scanning calorimeter. The thermogram is shown in FIG. 3. Hardly any wax is molten at 80° C. In between 80° C. and 100° C., only a small fraction of the Polywax 2000 undergoes a phase transition. The peak in the thermogram, representing the wax melting transition has a high slope. The maximum of this peak is at about 170° C.

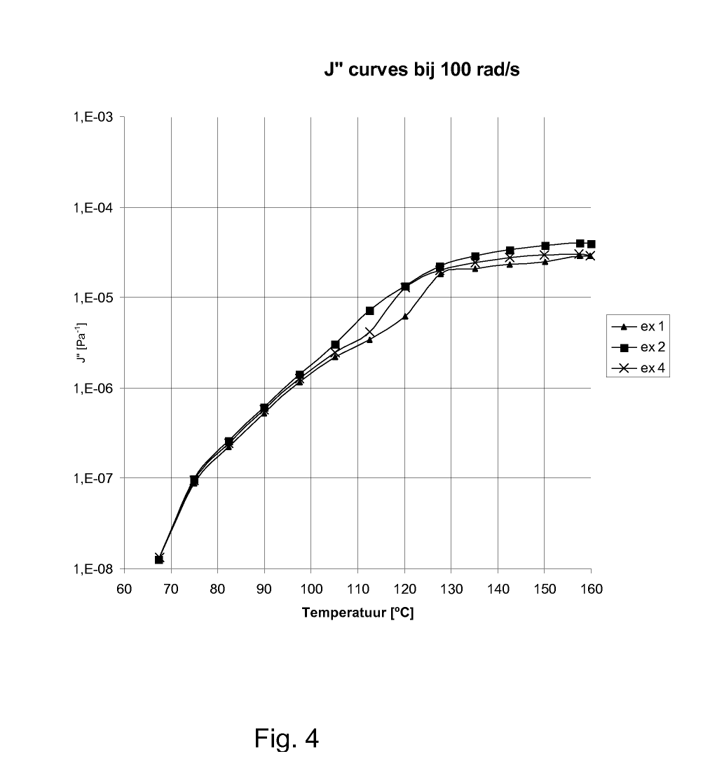

The Loss Compliance of toners of Examples 1, 2 and 4, measured at 100 rad/s are shown in FIG. 4 (see also section Experiments and Examples).

### Analysis

### Experiments and Examples

### Materials

All chemicals were used as received, unless stated otherwise. The magnetic pigment Bayoxide, an ironoxide (Fe₃O₄) originates from LanXess (Germany). Polywaxes 1000, 2000, 3000, which are polyethylene waxes, were obtained from Baker Petrolite. An additional polyethylene wax, PW X, a non-commercial product, was also obtained from Baker Petrolite. PW X is a product, analogous to the polywaxes, having a Mₙ of 1750 g/mole.

AC-330, AC-395a are oxidized HDPE waxes and are obtained from Honeywell. Ceraflour 950 (CF 950) is a micronized modified HDPE wax and was obtained from BYK.

The Epikote 828 resin was obtained from Nuplex Resins B.V. The polyester resin, being a reaction product of ethoxylated 2,2-bis(4-hydroxyphenyl)propane, a phthalic acid and adipine acid, having an acid value of 8 mg KOH/g and a Tg of 57° C. was obtained from Kao Corporation S.A.

The properties of the first waxes and the compatibilizers used are summarized in table 1 and 2, respectively.

TABLE 1

| | Tₘₑₗₜ (° C.) | viscosity at | acid | M_{W} |
|---|---|---|---|---|
| First wax | (first run) | 140° C. (mPa s) | number | (g/mole) |
| Polywax 1000 | 112 | 13 | 0 | 1100 |
| PW X | 121 | 26 | 0 | 1925 |
| Polywax 2000 | 127 | 65 | 0 | 2200 |
| Polywax 3000 | 128 | 143 | 0 | 3300 |

TABLE 2

| Compatibilizer | Tₘₑₗₜ (° C.) | viscosity at | acid | M_{W} |
|---|---|---|---|---|
| (second wax) | (first run) | 140° C. (mPa s) | number | (g/mole) |
| AC-330 | 130 | 4100 | 30 | 9000 |
| AC-395a | 130 | 4200 | 40 | 7000 |
| CF 950 | 135 | 4200 | 30 | 9000 |

### Methods

The DSC thermogram of the waxes and of the toners comprising the waxes is determined using a differential scanning calorimeter at a heating rate of 10° C./min at the time of rise according to the ASTM D3418 Standard using a TA Instruments Q2000 Differential Scanning calorimeter. The endothermic enthalpy is measured during the first and second scan of heating. The lower limit temperature and upper limit temperature of the wax melting transition is obtained from both the first and second scan of heating. The crystallization enthalpy of the wax and of the toners comprising the waxes is measured at the time of cooling down using a differential scanning calorimeter at a cooling rate of 10° C./min.

The working range of the toner transfer can readily be determined for a specific device by measuring the temperature range within which complete transfer and good adhesion of the powder image are obtained. A reasonable indication of the position and size of the working range of a specific toner powder can be obtained by measuring the visco-elastic properties of the toner powder. Generally speaking, the working range of the toner powder corresponds to the temperature range within which the loss compliance (J″) of the toner powder, measured at a frequency equal to 0.5 times the reciprocal of the contact time in the device used for performing the process according to the invention, is between 10⁻⁴ and 10⁻⁶ m²/N (see also FIG. 4).

The visco-elastic properties of the toner powder are measured in an ARES rheometer by TA instruments, the moduli G′ and G″ being determined as a function of the frequency at a number of different temperatures. The moduli G′ and G″ are measured in a temperature range of 60° C.-160° C. and a frequency range of 40-400 rads⁻¹ and a strain of 1%. The curves found are then reduced to one curve at one temperature, the reference temperature. From this reduced curve the loss compliance (J″) is calculated as a function of the frequency. The displacement factors of the lower fusing limit and upper fusing limit temperatures (J″=10⁻⁶ and J″=10⁻⁴ m²/N respectively) of the working range can then be read off from the loss compliance-frequency-curve.

The weight-averaged molecular weight of the binder resins and waxes is determined by GPC measurement with UV and refractive index detection. For GPC measurements on the waxes, a Varian PL-GPC220 with Viscotek 220R viscosimeter was used, provided with Viscotekk TriSEC 2.7 software and a PL 13 μm mixed olexis column. 1,2,4-Trichlorobenzene was used as eluent and the GPC column oven was at 160° C.

The polyester resin was analyzed a Varian PL-GPC220 with Viscotek 220R viscosimeter, provided with Viscotekk TriSEC 3.0 software and a set of 4×PL gel Mixed-C (5 μm) columns and a PL-gel guard column (5 μm). The column temperature was 30° C. and the TDA-detector temperature was 30° C. THF (Rathburn, HPLC grade) to which 5 wt % acetic acid was added, was used as eluent at a flow rate of 1 ml/min. Epoxy polymer was analyzed as the polyester resin, but the columns used were 2×PL-gel mixed E (3 μm) column and a PL-gel guard column (5 μm).

The quality of the dispersion of the wax in the toner binder resin is analyzed by using SEM pictures of the extrudated toner mixture. The SEM pictures were generated using a SEM JSM 6500 F machine. The volume median average size (D50)_{wax} of the wax domains is determined using SEM pictures of the extrudated toner mixture and of the classified toner particles. In a collection of wax domains present in toner particles, the volumes of the wax domains have a certain distribution. The volume median average size (D50)_{wax} is defined as the volume size that splits the distribution, such that 50% of the wax domains have a volume that is larger than (D50)_{wax} and 50% of the particles has a volume smaller than (D50)_{wax}. If the D50_{wax} is in the range of 0.1-5.0 μm, the first wax is considered to be finely dispersed in the toner composition (good dispersion). In case the D50_{wax} is higher than 5.0 μm, the first wax is considered to be poorly dispersed in the toner composition (rough dispersion).

### Magnetisation of the Toner Powder is Determined Using a Vibrating Sample

Magnetometer, of the type LakeShore 7300. The saturation magnetization value can be defined as an amount of magnetic memory under the condition where a magnetic field at 10 kilo-Oersted was applied to magnetic powder up to saturation. The saturation magnetization value of (magnetic) toner powder can be calculated by analyzing a hysteresis curve of that powder.

The resistance may be measured in a manner generally known, by measuring the dc resistance of a compressed powder column. A cylindrical cell is used to this end, having a base surface area of 2.32 cm² (steel base) and a height of 2.29 cm. The toner powder is forcibly compressed by repeatedly adding toner and tapping the cell 10 times on a hard surface between each addition. This process is repeated until the toner will not compress any further (typically after adding and tapping 3 times). Next, a steel conductor having a surface area of 2.32 cm² is applied to the top of the powder column and a voltage of 10V is applied across the column, following which the intensity is measured of the current that is allowed through. This determines the resistance of the column in the Ohmmeter.

### Smearing

Prints were made on Océ VP 6250. Transfer of the toner image to the image receiving medium is done in a transfuse step. After the toner image was transferred to the image receiving medium (Océ, red label), the image was optionally fused using a hot-roll fuser. Optionally, Océ fuser oil was applied to the hot-roll. If oil was applied, 1.7 mg of oil were used per sheet of A4 paper.

24 Hours after printing, the printed sheets were transferred to a Kern K905 cut sheet feeder. Sheets were separated for the pile of paper positioned on the cut sheet feeder. The sheet of paper that is separated is the sheet that is positioned on the bottom of the pile. The sheets separated from the pile by the cut sheet feeder were scanned using a flatbed scanner. The images were scanned at a resolution of 2400 dpi. The shorter side of the sheet is divided into 20 segments of 10 mm when scanning. For each segment, the smearing S is determined as described below. In an area of 10×2.11 mm, the lightness of each pixel of 10.5 μm×10.5 μm is measured. The lightness is in between 0 and 255. Smearing of toner leads to lower lightness values, because the sheets get contaminated by the smeared toner. Therefore, smearing of toner can be detected by lower lightness values. Only non-white pixels in the measured area having a lightness lower than a threshold value are taken into account. The threshold depends e.g. on the type of receiving medium used. In this case, the threshold is 18. The measuring program used recognizes clusters of neighboring non-white pixels having a lightness lower than the average lightness minus the threshold value. The total surface is a measure for smearing. The measured value S, which is a measure for smearing, is calculated as the product of the number of scanned pixels and the average grey level (lightness) lower than the threshold, for all measured clusters. The value S is in between 100 and 3000. Thus, the S value takes into account the magnitude of the surface that is contaminated by smearing and the intensity of the smearing. A mark (M) is given that relates to the smearing. If M is 1, there is a lot of smearing (bad result), a M of 7 corresponds to a very good result (no smearing). M is defined as: M=4.41/(0.0001*S)^{0.37}−0.5

### Reprint

Prints were made on Océ VP 6250. Transfer of the toner image to the image receiving medium is done in a transfuse step. After the toner image was transferred to the image receiving medium, (Océ red label, 80 gr/m²) the image was fused using a hot-roll fuser having a temperature of 180° C. No additional oil was used. During this fuse step, toner, or components of toner may be transferred from the image receiving medium to the hot roll fuser. The toner transferred to the hot roll fuser may be transferred to another image receiving medium, which is fused by the hot roll. This transfer of toner may thus cause ghost images on sheets of image receiving media which are fused afterwards. This phenomenon is called reprint. The occurrence of reprint is unwanted.

### Production Example 1

### Preparation of Toner

88 parts by weight of a polyester resin (a reaction product of ethoxylated 2,2-bis(4-hydroxyphenyl)propane, a phthalic acid and adipine acid, acid value: 8 mg KOH/g, Tg: 57° C.) and 88 parts by weight of an epoxy polymer were mixed in a premixer. The epoxy polymer is a Epikote 828 derivative. The Epikote 828 resin has an epoxy group content of 5.32. To lower the Epoxygroup content of the resin, 80% of the free epoxygroups present was converted into an ether functional group by reacting the Epikote 828 resin with para-phenylphenol, yielding the Epikote 828 derivative as a resin having an Mn of 1100 g/mol and an Mw of 1400 g/mol and a Tg of 49° C. Then, 200 parts by weight of a magnetic pigment Bayoxide, an ironoxide (Fe₃O₄) which originates from LanXess (Germany), 8 parts by weight of a compatibilizer, being a high density oxidized polyethylene AC 330 wax, and 16 parts by weight of a first wax, being Polywax 2000, were added and the mixture was premixed. Subsequently, the pre-mixed mixture was transferred into a melt-kneading device (a Buss extruder, Buss MDK 46-15D). In the melt-kneading device, the mixture is mixed in four different zones. The temperature in the first zone is 60° C., the temperature in the second, third and fourth zone is 95° C. The mixture is kneaded at 400 rpm. Melt-kneading of the mixture resulted in an extrusion product having a density of 1.89 g/cm³, a magnetization of 15.74 mVs/g and a remanence of 4.86 emu/g.

The obtained mixture was then milled in a jet-mill, followed by classification to give toner particles of toner composition 1. The surface of the toner was coated with carbon black (originating from Degussa—Germany) at a level of 1.6 parts carbon per 100 parts by weight toner particles. Further the surface of the toner was coated with a hydrophobic silica at a level of 0.3 parts silica per 100 parts toner particles. The electrical resistivity of the toner particles after the coating process was 1.0*10⁵ Ωm. The magnetisation of the toner particles was 15.38 mVs/ml or 29.01 mVs/cc. The remanence was 4.85 emu/g, the density was 1.887 g/cm³. The toner particles have a volume median average particle size (D50) of 15 μm, and a D5/D95 of 1.99. D5/D95 is a measure for the size distribution and is defined as the ratio between D5 (5% of the particles have a volume size that is smaller than D5) and D95 (95% of the particles have a volume size that is smaller than D95). SEM measurements showed that the wax was well dispersed within the toner composition.

### Production Examples 2-9

Toner compositions 2-9 were prepared in production examples 2-9, according to production example 1, wherein the first waxes and the compatibilizers were varied. The total amount of the first wax and the compatibilizer was always 6% by weight, based on the weight of the binder resins, the colorant, the first wax and the compatibilizer. The toner compositions 2-9 are summarized in table 3.

TABLE 3

| | | | | amount of | Dispersion |
|---|---|---|---|---|---|
| toner | | | amount of | com- | wax in |
| com- | | | first wax | patibilizer | binder |
| position | First wax | compatibilizer | (m %) | (m %) | resin |
| 2 | Polywax | AC-330 | 4 | 2 | finely |
| | 1000 | | | | |
| 3 | Polywax | AC-395a | 4 | 2 | finely |
| | 1000 | | | | |
| 4 | PW X | AC-330 | 4 | 2 | finely |
| 5 | PW X | AC-395a | 4 | 2 | finely |
| 6 | Polywax | AC-395a | 4 | 2 | finely |
| | 2000 | | | | |
| 7 | Polywax | CF 950 | 3.5 | 0.5 | finely |
| | 3000 | | | | |
| 8 | Polywax | CF 950 | 3 | 1 | finely |
| | 3000 | | | | |
| 9 | Polywax | CF 950 | 2.66 | 1.33 | finely |
| | 3000 | | | | |

In all toner compositions 1-9 the first wax was finely dispersed in the toner composition.

The toners according to example 1-9 were tested in a Océ VP 6250 toner imaging system at a long duration, e.g 50.000 prints. Contamination of the developing means and intermediate image bearing means due to (partial) melting of the first wax (or compatibilizer) in the toner imaging system was not observed.

### Comparative Production Examples

As comparative examples, toners were prepared in comparative production examples 1-4. The toners (CE 1-CE 4) prepared in the comparative production examples do not comprise both a first wax and a compatibilizer, being a second wax. Instead, the toners according to the comparative examples comprise only one wax. The total amount of the wax was always 6% by weight, based on the weight of the binder resins, the colorant, and the wax. The comparative examples CE 1-CE 4 are summarized in table 4.

TABLE 4

| Comparative | First wax | | | Dispersion wax |
|---|---|---|---|---|
| example | ([wt %]) | | Compatibilizer | in binder resin |
| CE 1 | PW 1000 | [6 wt %] | — | rough |
| CE 2 | PW X | [6 wt %] | — | rough |
| CE 3 | PW 3000 | [6 wt %] | — | rough |

| | | | |
|---|---|---|---|
| CE 4 | — | AC 330 [6 wt %] | —¹ |

¹No first wax in accordance with the present invention was present in the toner of comparative example 4. However, the AC-330 wax was well dispersed within the toner composition.

The toners according to comparative examples CE 1-CE 4 were tested in a Océ VP 6250 toner imaging system at a long duration, e.g. 50.000 prints. Contamination of the developing means configured and intermediate image bearing means due to (partial) melting of the first wax (or compatibilizer) in the toner imaging system was observed for comparative examples CE 1-CE 3. In case of comparative example CE 4, no contamination of the developing means or intermediate image bearing means was observed.

### Printing Examples and Comparative Printing Examples

The number of the printing example corresponds to the number of the toner composition used in the printing example.

In a first printing experiment, the smearing of images printed using toner compositions 7, 8 and 9, respectively, was compared. Toner compositions 7, 8 and 9 comprise the same first wax (PW 3000), the same compatibilizer (Ceraflour 950) and the same total amount of the first wax and the compatibilizer (6 wt %). However, the ratio between the amount of first wax and the amount of the compatibilizer varies. The results are summarized in table 5.

TABLE 5

| | amount of 1^{st} wax | | |
|---|---|---|---|
| toner | [wt %]:amount | M (no second | M (second fuse |
| composition | compatibilizer [wt %] | fuse step) | step at 170° C.) |
| 7 | 7:1 | 2.6 | 4.0 |
| 8 | 3:1 | 2.6 | 3.9 |
| 9 | 2:1 | 2.2 | 4.0 |

For all examples 7-9, the mark for smearing increases upon undergoing a second fuse operation; i.e. the amount of smearing decreases. Without wanting to be bound to any theory, it is believed that upon applying a second fuse step, the first wax may migrate to the surface of the toner particles, thereby providing a smoother surface to the toner image, thereby decreasing smearing. The differences between the marks for smearing after applying a second fuse step, between the toner composition comprising the same first wax and the same compatibilizer, but differing in the ratio between the amount of the first wax and the compatibilizer, are within measuring accuracy. In case a second fuse step was carried out, oil was applied to the hot roll fuser.

Comparison between examples 7, 8 and 9 shows that amount of compatibilizer with regard the amount of wax may suffice to obtain a toner according to the present invention. Increasing the relative amount of compatibilizer does not further improve the smearing of the toner.

In a second printing experiment, the smearing of images printed using toner compositions 1, 2 and 4-6 and comparison experiments CE 1-CE 4 were compared. The toners according to the present invention tested in this second comparison experiment comprise different combinations of the first wax and the compatibilizer. The toners according to the comparative examples comprise either a first wax or a compatibilizer, not both. The results are summarized in table 6.

TABLE 6

| | | | M (no | M (second | |
|---|---|---|---|---|---|
| toner | first | | second fuse | fuse step at | system |
| composition | wax | comp. | step) | 170° C.) | pollution |
| 1 | Polywax | AC-330 | 2.7 | 4.2 | no |
| | 2000 | | | | |
| 2 | Polywax | AC-330 | 2.8 | 3.6 | no |
| | 1000 | | | | |
| 4 | PW X | AC-330 | 2.7 | 3.8 | no |
| 5 | PW X | AC-395a | 2.5 | 3.7 | no |
| 6 | Polywax | AC-395a | 2.6 | 4.4 | no |
| | 2000 | | | | |
| CE 1 | Polywax | — | 2.5 | 4.8 | yes |
| | 1000 | | | | |
| CE 2 | PW X | — | 2.8 | 4.9 | yes |
| CE 3 | Polywax | — | 2.8 | 4.8 | yes |
| | 3000 | | | | |
| CE 4 | — | AC330 | 2.8 | 4.0 | no |

For all examples as well as for all comparative examples, the mark for smearing was in the range of 2.5-2.8 when no second fuse step was applied to the toner image. Upon applying a second fuse step, the smearing improved. Examples 1, 2, 4-6 and CE 4 showed an improvement in smearing, whereby the mark for smearing improved to 3.6-4.2. Thus, the smearing improved upon applying a second fuse step.

For CE 1-CE 3, the smearing improved as well and improved even more than for the other toner compositions. However, the toners according to CE 1-CE 3 pollute the developing means and/or intermediate image bearing means. The toners according to examples 1, 2, 4-6, on the other hand, do not lead to pollution of the developing means and/or intermediate image bearing means and therefore are suitable for use in a printing system in accordance with the present invention and still provide an improvement with regard to smearing upon application of a second fuse step.

In a third printing experiment, the effect of a second fuse step on toner images printed using toner compositions 2, 4, 5 were compared to the effect of a second fuse step on toner images printed using toner compositions CE 2, CE 4. The results are summarized in table 7.

TABLE 7

| toner composition | first wax | comp. | reprint |
|---|---|---|---|
| 2 | Polywax 1000 | AC-330 | no |
| 4 | PW X | AC-330 | no |
| 5 | PW X | AC-395a | no |
| CE 2 | PW X | — | no |
| CE 4 | — | AC330 | yes |

Prints made with toner compositions 2, 4 and 5 do not show reprint when undergoing a fuse step in the hot roll fuser. Also prints made with toner composition CE 2 do not show reprint when undergoing a fuse step in the hot roll fuser. Prints made with toner compositions CE 4, on the other hand, do show reprint.

In summary, toners according to the present invention and prints made with these toners were compared with comparative examples of toners and prints made with these toners, regarding dispersion of the wax in the toner, smearing of the print after a fusing step using a hot roll fuser, as well as without a fusing step using a hot roll fuser, and occurrence of reprint. Toner compositions in accordance with the present invention show a fine dispersion of the wax within the toner particles, showed an improved mark for smearing upon an additional fusing step, did not show reprint after an additional fusing step and did no show any system pollution.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

1. A toner for developing a toner image, the toner comprising:
(i) a binder resin;
(ii) a colorant; and
(iii) a first wax and
(iv) a compatibilizer, the compatibilizer being a second wax different from the first wax, said compatibilizer having a melting transition, wherein the lower temperature limit of the melting transition is between 110° C. and 140° C. at a time of temperature rise in a DSC thermogram measured using a differential scanning calorimeter and wherein the compatibilizer is selected from an oxidized polyalkylene.

2. A toner according to claim 1, wherein the first wax has an acid value of from 0 mg KOH/g to 50 mg KOH/g.

3. A toner according to claim 1, wherein the compatibilizer has an acid value of from 10 mg KOH/g to 80 mg KOH/g.

4. A toner according to claim 1, wherein the melting point of the first wax is in the range of 110° C. to 135° C.

5. A toner according to claim 1, wherein the weight averaged molecular weight (M_{w}) of the first wax is in the range of from 1000 g/mole to 4000 g/mole.

6. A toner according to claim 1, wherein the weight averaged molecular weight (M_{w}) of the compatibilizer is in the range of from 6000 g/mole to 15000 g/mole.

7. A toner according to claim 1, wherein the compatibilizer is selected from an oxidized polyethylene.

8. A toner according to claim 1, wherein the first wax is selected from a polyalkylene wax.

9. A toner according to claim 1, wherein the colorant is a magnetic pigment.

10. A printing system for applying a toner on an image receiving medium, the toner comprising:
(i) a binder resin;
(ii) a colorant; and
(iii) a first wax; and
(iv) a compatibilizer, the compatibilizer being a second wax different from the first wax, said compatibilizer having a melting transition, wherein the lower temperature limit of the melting transition is between 110° C. and 140° C. at a time of temperature rise in a DSC thermogram measured using a differential scanning calorimeter,
the printing system comprising:
(A) a developing means configured for in operation developing a toner image,
(B) an intermediate image bearing means configured for in operation transferring the toner from the developing means to the intermediate image bearing means in a first transfer zone and for transferring the toner from the intermediate image bearing means to an image receiving medium in a second transfer zone.

11. A printing system for applying a toner on an image receiving medium according to claim 10, wherein the printing system further comprises:
(C) fusing means for in operation fusing the toner image on the receiving medium.

12. A method for producing a toner comprising the steps:
(i) providing a binder resin,
(ii) providing a colorant,
(iii) providing a first wax, and
(iv) providing a compatibilizer, the compatibilizer being a second wax different from the first wax, said compatibilizer having a melting transition, wherein the lower temperature limit of the melting transition is between 110° C. and 140° C. at a time of temperature rise in a DSC thermogram measured using a differential scanning calorimeter,
(v) mixing the binder resin, the colorant the first wax and the compatibilizer in a melt kneading process in a melt temperature range between 110° C. to 140° C., such that the first wax is finely dispersed in the binder resin.
